(19) United States
(12) Patent Application Publication
(10) Pub. No.: US 2022/0374860 A1
(43) Pub. Date: Nov. 24, 2022

(54) IOU (I owe you) currency platform

(71) Applicant: IOU Notes, LLC., Davie, FL (US)

(72) Inventor: Shawn Snow, Davie, FL (US)

(73) Assignee: IOU Notes, LLC., Davie, FL (US)

(21) Appl. No.: 17/300,292

(22) Filed: May 12, 2021

(51) Int. Cl. G06Q 20/24; G06Q 20/10; G06Q 20/40

(52) U.S. Cl. CPC G06Q 20/24; G06Q 20/102; G06Q 20/108; G06Q 20/4014

(57) ABSTRACT

A platform that provides individuals and businesses with the ability to provide credit and/or lend money to other individuals and businesses using an IOU (I Owe You) form of currency. The platform comprises different modules which can be used alone or in combination. The platform allows individuals and businesses with the ability to securely and easily setup and track transactions, establish repayment terms of their choice (30, 45, 60, 90 days, etc), interest rate (no interest, 1%, 2%, 3%, etc.) and other related functions with others in one convenient platform from account signup through to funds settlement. Users (individuals and businesses) can access the platform from a cell phone, tablet, laptop computer, desktop computer or any other related internet browser.

### FIELD OF THE INVENTION

The invention relates to a platform that provides individuals and businesses with the ability to provide credit and/or lend money to other individuals and businesses using an IOU (I Owe You) form of currency. The platform comprises different modules which can be used alone or in combination. The platform allows individuals and businesses with the ability to securely and easily setup and track transactions, establish repayment terms of their choice (30, 45, 60, 90 days, etc), interest rate (no interest, 1%, 2%, 3%, etc.) and other related functions with others in one convenient platform from account signup through to funds settlement. Users (individuals and businesses) can access the platform from a cell phone, tablet, laptop computer, desktop computer or other related internet browser.

### BACKGROUND OF THE INVENTION

In the modern economy individuals and businesses pay for products and services using different forms of payments. These come in the form of a pay now or pay later method. The IOU (I Owe You) platform focuses on the pay later method.

Traditional pay now methods include paper money of that particular government (example, US Dollar), debit card, check, trade products and services, or bank wire for larger purchases where the money is changed in real time from buyer to seller. For the purpose of the invention listed herein this publication, it is common knowledge on the pay now methods listed above. Many publications have been written about these payments and most people already understand and use them in their daily lives so we do not devote much time explaining them in detail.

Traditional pay later methods include credit cards, installments such as car payments, mortgages, other loans, and lines of credits for personal and business use from different institutions. For the purpose of the invention listed herein this publication, it is common knowledge on the pay later methods listed above. Many publications have been written about these payments and most people already understand and use them in their daily lives so we do not devote much time explaining them in detail.

Another form of borrowing (pay later method) consists of writing an IOU (I Owe You) note. This method is where a person borrows money from family, friends, and others in an informal way. It is with the intention to pay back but a lot of time either people start asking for the money back, or are too embarrassed to ask, or the person does not pay back and it creates tensions in the relationship. Certain businesses also offer to their client's forms of credit for their goods or services and clients generally have 30 days to pay back. These business relationships are built over many years to establish payment and client history. When an individual or business starts to try to work with other vendors, that vendor pulls their credit report to see their history and decides whether or not to extend credit. Pulling a credit report too often has a negative effect on that individual or business. This results in making sense only to ask new vendors for credit on larger types of purchases, and not small and mid size purchases.

The term IOU (I Owe You) has a history dating to the 18th century. It is often viewed as an informal written agreement acknowledging debt. An IOU between two people conducting business may be followed up with a more formal written agreement. There is no standard format for an IOU. Criteria such as repayment terms, time of payment, interest due, and payment type may or may not be included. Nowadays there are legal templates available now for IOUs and provide an outline of the kind of details that should be included.

An example of an IOU in the marketplace is as follows. Say ABC Construction Company places an order for lumber and other building materials and does not have enough in payment (credit card, cash, check) to pay for the entire order when it is delivered. Instead, company pays a down payment and issues an IOU (I Owe You) promising to pay for the rest of the materials within 30 days with or without interest. Assuming that supplier is ok with this and has an established business relationship with ABC Construction Company, an IOU will be accepted by both parties.

For accounting purposes, an IOU is recorded as an outstanding debt. The IOU is thus an accounts receivable item and is counted as an asset on the balance sheet. If the money is due in one year or less, the IOU is listed as a current asset. If the payment is due more than a year down the road, the IOU is recorded as a long-term asset.

There are many situations where individuals and businesses need to borrow money to either pay for immediate expenses (food, rent/mortgage, child expenses, family expenses, etc.) or business expenses (payroll, inventory, supplies, etc.). Current options to borrow are from banking and lending institutions who charge high interest rates. Some credit cards offer zero or low interest rates for a time period but then afterwards interest rates spike up as much as 29% APR (annual percentage rate) plus late and other fees. These credit cards companies lure people into their trap knowing that there will be many people who fall into this interest trap. Once in debt it is hard to get out.

### SUMMARY OF THE INVENTION

People have been providing credit, borrowing, and lending to each other since the beginning of time. While this concept is not new, the invention (IOU [I Owe You] Platform) (also referred to as IOU Notes) has created a platform where transactions can safety and easily take place, be tracked, etc. in one convenient platform. Every account created must be a real person or business entity and go through a verification process by uploading the proper form of identification. Profiles can be set to public where everyone can see or private mode so just the individuals and businesses that are working together can see.

IOU Notes, IOU Account, IOU Platform, IOU Credit, IOU Currency, IOU Payment, IOU Loan, and IOU Code are all terms of the IOU (I Owe You) Currency Platform that will be used as part of the invention. IOU Notes™, IOU Account™, IOU Platform™, IOU Credit™, IOU Currency™, IOU Payment™, IOU Loan™, and IOU Code™ are trademarks that are being claimed and used in commerce by the applicant and should be noted. Throughout patent publication the abbreviation IOU which stands for I Owe You is used without the (I Owe You) term each time and should be noted.

In the case of lending money between 2 users, first the user (individual or business) accesses the IOU Platform (also referred to as IOU Notes) from their cell phone, tablet device, laptop, or desktop computer. Platform can be downloaded to their device as an application stored on their device or they can access through any Internet browser by going to the website address of the IOU Platform. Either way user (individual or business) would first login into their account. User would next use the search bar and find the person or business that they are requesting the loan from. They could search for that person or business by entering their name, phone number, or email address. The search results would then display the exact person that it matched when entering phone number or email address. In the case of just entering person's name, next to the person's name would display the city that they are from if more then one person has the same name. User then can then select the correct person and send a request to them to accept and allow them to view their profile. System would send access request to that particular person and they are alerted by email, and in their IOU Account (also referred to as account). Once this is accepted both users can see each other's profiles and they will have access to send or accept lending requests. When searching for businesses after entering the name if business has more then 1 location they can select the one they want by the address that comes up in the search results.

In the case of providing credit, first the user (individual or business) accesses the IOU Platform from their cell phone, tablet device, laptop, or desktop computer. Platform can be downloaded to their device as an application stored on their device or they can access through any Internet browser by going to the website address of the IOU Platform. Either way user (individual or business) would first login into their account. User would next use the search bar and find the business that they are requesting credit from. If business more then 1 location they can select the one they want by the address that comes up in the search results. After selecting the business, user would send credit request by clicking corresponding button. System would send credit request to that particular business and they are alerted by email, and in their IOU Account (also referred to as account). Business will then be given access to view user's account profile, and IOU Credit report (also referred to as credit report or details) where they can decide if they should give that user (individual or business) credit and how much of it. Business can also set in their account for everyone or a case by case basis other parameters such if there is an interest rate and that rate and credit length term from the time of each purchase.

Before a user (individual or business) can access the IOU Platform, he/she must register with the platform. Users can apply online at IOU Platform website from a laptop or desktop computer, cell phone, tablet or other device connected to the Internet or download the application to their mobile device (cell phone, tablet device) using wireless internet.

As part of the registration process individual user inputs their personal information such as name, address, cell phone, other phone if applicable, email address, date of birth, social security number, and also uploads the proper form of identification such as driver's license, state id, passport, etc). Then submits everything for review by using the submit button.

As part of the registration process business users inputs their business information such as business legal name, business trade name if applicable, company type [c corporation, s corporation, partnership, limited liability corporation, etc], business address, business phone, other phone if applicable, business email address, business federal identification number, date business started, and also uploads business documents such as corporate record, fictitious name record if applicable, EIN/TIN letter, etc. In addition, corporate officers must also input their personal information such as name, address, cell phone, other phone if applicable, email address, date of birth, social security number, and also uploads the proper form of identification such as driver's license, state id, passport, etc.). Then submits everything for review by using the submit button.

New users (individuals and businesses) have to go through a verification process and be accepted on the IOU Platform to use the platform and related various functions. When a user completes registration form and clicks the submit button, the IOU Platform receives the request from new user to open an account and verification process begins. An IOU Platform agent starts verification process. Every account created must be a real person or business entity and go through verification process where the user is confirmed to be a real person or business entity. Next it must also be determined that the individual or business entity is the one requesting the account and not a third party. Next it also must be determined that there are no other open accounts already in use on the IOU Platform with this individual or business entity. The IOU Platform does not allow duplicate accounts, second accounts, fake name accounts, personal alias accounts (only businesses can have a fictitious name tied to a corporate entity), and the like. To preserve the integrity of the IOU Platform each individual user or business entity will be allowed only one account. Users can delete their account if they choose or the IOU Platform may also delete a user that violates its Terms and Conditions, which users will have access to from their account and website. If a user deletes their account and then at a later time wants to open an account, verification process starts again but new account is not created, old user account will be reinstated with IOU Credit History, Balances, and all other account functions intact to its original state when user decided to delete.

Once a user (individual or business) is registered and validated, his/her profile, including name, address, phone number, email address, password, etc. is stored in the IOU Platform database and a particular account will be associated that that user.

Each time a transaction takes place (credit or loan), the details of that transaction is placed both into the sender and receivers IOU Platform account. In the case of a loan, funds would be transferred from lender's account into borrower's account. All details of the transaction such as but not limited to date, amount, loan length, and interest rate is recorded into each party's account. Each time a payment is made on borrowed loans, either paid in full or partial payments those details are also placed in each party's IOU Platform account.

In the case of IOU Credit (also referred to as credit) provided by a business either to an individual or another business all details of the transaction will also be placed in both user's IOU Platform accounts. Since IOU credit is being extended from one user to another, for these transactions funds are not being transferred initially. Instead user gives another user an IOU credit limit and then other user that received the credit purchases goods and/or other services from that business. Payment is paid at a later time to that business through user's IOU Platform account at any time or before due dates (30 days) or agreed upon interest (example 5% APR) will start. For illustration purposes, User A (John Doe) requests from User B (ABC Restaurant) an IOU Credit Request in the account by locating user (in this example User B—ABC Restaurant) that they want to request credit from and clicking on IOU Credit button. The IOU (I Owe You) platform next gets this request and sends an email to User (in this example User B—ABC Restaurant) and also notification get placed into their IOU (I Owe You) platform account. User will then be given access to view user's account profile, and IOU Credit report where they can decide if they should give that user (individual or business) credit and how much of it. Business can also set in their account for everyone or a case by case basis other parameters such if there is an interest rate and that rate and credit length term from the time of each purchase.

The IOU Platform works different from credit cards in the following manner. Banking or Credit card company extends a credit limit to a user (for example $1,000) and that user can spend the funds anywhere that card is accepted. User makes a purchase at a business (for example spends $250) and then another business in same day ($125) and takes possession of bought item or service from those businesses. Bank or credit card company gets details of transactions and send funds to those businesses.

The IOU Platform allows users to request or offer credit and/or loans directly to one another and function as the bank or credit card company. These companies extending the credit to other users decide the particulars. If they are extending credit to that other user, if so how much, and if there is a term length that it must be paid back by, and if any interest will be charged passed 30 days mark, and if so how much. Since they are extending credit directly to others, the user who receives the credit can purchase goods and services offered by that business.

The IOU Platform allows these businesses to create and generate new money activity into the economy. Traditional banks create money in the economy through the use of new loans to others such as mortgages, car loans, credit cards, etc. Each time a new loan is made to a borrower, banks create money by crediting those borrower's accounts with a bank deposit the size of that loan. Every new loan that a bank makes creates new money into the economy by just accounting entries on their computers. These numbers are a ‘liability’ or IOU from the bank to the customer. The customer can then use their credit card, debit card, check, or other forms of payment methods to spend those IOUs as though they were the same as real paper currency.

The IOU Platform extends the same power that banks have in creating and generating new money into the economy to all people and businesses. It can do this because when a product or service is exchanged for credit, that business extends to others directly at a credit limit level that they determine, which they base on past transactions with that user and other users based on their IOU Credit Score. Businesses who extend IOU Credit to others are not laying out additional funds each time a purchase is made like bank and credit card companies do. The IOU Platform does not add additional costs to produce goods or services offered by the business extending the credit. Profits plus original costs to produce goods or services are just delayed until customer pays off IOU Credit, back to these businesses.

Many service businesses in the economy currently extend a form of IOU (I Owe You) to their customers while not even realizing it. There are many types of businesses that operate this way of providing service and IOU Payment (also referred to as payment) is deferred until service is completed. This happens that same day which might be 15 minutes, 30 minutes, 1 hour, or 2 hours, etc. later when customer leaves from place of business or service has been provided, depending on the service being provided. These businesses operate on extending short term IOU to their customers everyday and are not even aware that it is going on.

There are hundreds of service business types and the majority operate on some kind of IOU, where they provide service first and get paid after service is completed. A few examples of these types of businesses include sit down restaurants, bars, hair salons, dentists, auto mechanics/service shops, home repair services, etc. Most of these businesses provide service first to the customer and there is no credit check, identification provided, collateral provided, or many times not even the customer's basic information (name, address, phone number) is asked for before service is provided. It has become standard practice in the marketplace for most service businesses to just provide the service and the customer will pay immediately afterwards. The IOU Platform takes this already established practice and extends it for a longer timeframe/pay later option and also includes this model to product based businesses and individuals operating as sole proprietorships.

The IOU Platform works to empower users (individuals and businesses) to have the same credit and loan making abilities (in an organized way) that are currently only available to large entities. Currently these Financial Institutions (Banks, Credit Unions, Lenders) and Larger Companies have the resources to provide credit and/or loans to others.

The current system of credit cards works in the following manner. In the case of applying for a credit card with a Financial Institution, users provide their personal information and that institution runs their credit score and then decides if that user gets approved, their credit limit and also their interest rate. Users can then purchase products and services from any business that accepts that credit card and have 30 days to pay off the balance to the credit card company before the interest starts on unpaid balances. A lot of credit card companies run promotions that do not charge interest during the introductory period.

For companies that have their own credit card program some are in house while others are run by an outside Financial Institution and works in the same manner as regular credit cards except card credit can only be used to purchase products and services from only that particular company. Credit interest rates vary in both scenarios but can go up to 29% APR (Annual Percentage Rate) plus late and other fees.

There are many reasons why credit cards interest rates and other fees are very high. The majority of credit cards are unsecured loans. Unlike a mortgage or an automobile loan, where the banking institution has collateral to take if the borrower does not make their loan payments, there is nothing the bank or card issuer can collect besides interest and a put out a negative credit rating for late payments. Another reason that credit card fees are very high is borrowers are unpredictable with their purchases. The card issuer does not know how often borrowers will use the card, how much will be charged (within credit limit provided), where it will be used, or when it will be paid back. This added risk translates into a higher interest rate to cardholders since banks issue unsecured credit to millions of people. Bank issuers never know when the balances will be paid off by their borrowers compared to the funds that they have laid out. High interest rates charged by these banking and credit card institutions allow these companies to operate and still make a profit.

Another form of loans in the marketplace is Payday loans. A payday loan is a short term loan that are offered to individuals to cover short term immediate cash needs until that individual gets their next paycheck. These small dollar (ranges from $50 to $1,000), high cost loans usually charge triple digit annual percentage rates (APRs), and payments are typically due within 14 days. If the loan is not paid back in full in that 14 day period, then late fees are assessed and many of these type of loans rollover and renew themselves. This means any partial payments that were paid go only towards interest and not the principal that was borrowed.

Payday loans function differently than personal and other consumer loans. Most companies that offer this type of loan is through a physical branch with a payday lender or online. Many payday lenders have few requirements for approval. Most do not run any credit check on their customers or even verify that the borrower can repay the loan. All is needed is typically a form of identification, a bank account, and a steady paycheck. According to many studies, payday loan APRs can total 400% or more when you factor in all the fees and interest. Many people that resort to payday loans, have poor credit or do not have other financing options.

The IOU Platform works differently from traditional loans, credit cards, payday loans, etc. Users (individuals and business) on the IOU Platform are borrowing (credit or loans) directly from other users (individuals and business) on the platform. Since they are working directly with these other users they can request credit or loans directly from those other users. They also pay other users back directly through the IOU Platform instead of paying one entity who then in turn pays all the vendors like traditional credit cards work. Users can also request an increase in credit from users that they are working with on the platform. The IOU Platform does have an easy option that users can pay all users that they owe funds to in one transaction or partially pay or decide which users to pay.

The IOU Platform gives any businesses the ability to offer their current and future customers an internal credit and pay later option that once was available to only larger companies that could issue their own store credit program. Leveraging the IOU Platform, small businesses can reach a larger audience in their community by offering a very attractive get product/service now and pay later and not have to worry about large interest rates. This service gives users the opportunity to change their spending habits to change and start to use the IOU Platform for the smaller and mid level purchases and use credit cards for only larger purchases. As more users signup on the IOU Platform and this form of currency is used and accepted everywhere, then in the future the IOU Platform can also be used for larger purchases also, as businesses allow and extend more credit to users.

For the purposes of the IOU Platform, the invention itself allows users to set their own interest rates and the maximum is reflected by the laws in their particular jurisdiction. It should be noted that the founder of the IOU Platform wishes that the invention in practical use in commerce will be to set the platform to a maximum of 5% APR that users can adjust to. This is for the usefulness and good affect that the IOU Platform can have on society. Every day more people are going deeper into debt and lives are ruined in financial debt. Credit Cards are a great tool when used correctly but other low cost short term credit and loans do not exist. The IOU Platform was created for this reason and benefits both individuals and businesses.

The IOU Platform has its own IOU Credit Score (also referred to as credit score) that users can utilize to evaluate others credit and loan worthiness and decide to do business with. This IOU Credit Score is independent of the traditional credit score used in the financial industry. Every user will have the opportunity to start from fresh and establish their IOU Credit Score. Their traditional credit score will not factor in at all and users should judge other users on the IOU Platform based on their IOU performance and not their traditional credit performance.

IOU Credit Score are calculated using many different forms of IOU Platform data. This data is grouped into many categories such as IOU payment history (which consists of number of IOU transactions, dollar amounts of IOU transactions, average length to IOU repayment), IOU amounts owed vs. IOU credit, length of IOU credit history, number of users with credit history with, working with other users in different business categories, and loan mix if applicable. With the IOU Platform the more users that other users have good working relationships with the higher their overall IOU credit score will be. This is because more users that extended credit and loans (if applicable) to other users and that they pay back regularly it displays that they honor their commitments with a large number of vendors.

IOU Credit Score considers both positive and negative information in the IOU Credit Report. Negative information will be such items as late payments, not paying backs IOU credit/loans, or paying them back very late. Reestablishing a good track record of making payments on time and changing related bad habits will raise overall the IOU Credit Score.

The IOU Platform has different components of calculating IOU Credit Score above and the overall method to determine IOU Credit Score for a particular user at any given particular moment has been presented for the purpose of illustration and description only and are not to be construed as limiting the scope of the invention in any way. These are different percentages of importance for each listed category.

Users IOU Credit Score can change frequently based on the constant input of new data (transactions and other related factors). In this section we will go over each deciding factor of the IOU Credit Score.

IOU Payment History: Other users on the IOU Platform whether they are lending money, or providing a product or service to other users wants to know that they will get paid what is owed to them. Next if they will get paid on time. IOU payment history also includes which other user accounts were paid on time, the amounts owed, number of other transactions, and the length of any late or non payments. This helps other users figure out the amount of credit or loan that they are willing to extend to that particular other user.

IOU amounts owed vs. IOU credit: This data includes the number of other users accounts that are owed money to, the type of debt, and its total amount. Also included is the ratio of money owed to credit available also known in traditional credit industry as credit utilization rate.

Length of IOU Credit History: This data includes a wide range of variables such:
How long user has been on the IOU Platform.
The age of transactions with user's newest, oldest, and average age of all other users.
Different types of users (example: different business categories) and user's transactions with them.

The IOU Platform has a rating system for its IOU Credit Score that ranges from 200 Points to 1,000 points and using a grading system A+, A, A−, B+, B, B−, C+, C, C−, D+, D, D−, and F+, F, F−.
A+: 950-1000 points
A: 900-949 points
A−: 850-899 points
B+: 800-849 points
B: 750-799 points
B−: 700-749 points
C+: 650-699 points
C: 600-649 points
C−: 550-599 points
D+: 500-549 points
D: 450-499 points
D−: 400-449 points
F+: 350-399 points
F: 300-349 points
F−: 299 points and below

The IOU Platform allows users to set small amounts of credit such as starting at $25 to other users and they decide to slowly or quickly raise their IOU Credit after payments. Each user will establish different relationships with different users so credit will be reflected at such. For example, user A has starting credit user B for $25. Over time and after successful repayment, user B raises credit limit periodically and now for example at $125. Other users that user A has been working with have different credit limits with user A that have been established over time, such as User B has credit limit of $125, User C has $50, User D $300, User E $750, User F $75, etc.

For a lot of people having to much credit and not being financial disciplined in combination with a high interest rate (traditional credit cards up to 29% plus late and other fees) is a recipe for financial disaster. People also know that the vendors will end up getting paid by the credit card company and do not feel too guilty when not able to pay back because the credit card companies are charging such high interest rates.

Furthermore the IOU Platform encourages sound fiscal responsibly by users paying back directly to what is owed to other users (individuals or businesses) and that the users that they are working with have an interest rate cap of 5% APR. In this scenario if other users do not get paid back that user is not only hurting those other user(s) directly but after a certain amount of time, user will not be about to use The IOU Platform until these outstanding debts are paid back.

For example, for purposes of illustration if IOU Platform was set to 6 months late payments in user accounts, any other user that was owed money and 6 months late that user would have to pay those account balances first before platform will allow them to make future purchases or loan requests. This ensures that all users will get back the funds that are owned to them. Since user is only allowed one individual account if they are an individual, sole proprietor or business entity it is in their best interest to pay what they owe if they want to continue to use the IOU Platform. Even if they stopped using the IOU Platform and came back many years later they would still have to continue with their already established account and could not start a new one.

The IOU Platform only allows one account per individual or business entity. Every account created must be a real person or business entity and go through a verification process by uploading the proper form of identification. For Individuals, acceptable forms of identification include Drivers License, State ID, Social Security Card, Passport and/or other acceptable form required by law. For Business Entities, acceptable forms of identification include Corporation Record, Business Tax #, Fictitious Name record (if applicable), etc. plus identification of the corporate officers. Once opened, that user has one account to work with. If they are careless and do not pay the IOU Platform credit and loans that they accepted on the system then they will have wasted a powerful opportunity. Users that are in default can paid back their outstanding debts and work their way back into good standing.

The IOU Platform follows the currency of that particular country that users are using the platform. For example, if two users have USA accounts then their transactions will be in the USA Dollar and so on. The IOU Platform is for all countries and all aspects of the invention discussed and illustrated throughout these invention papers apply for use in all Foreign countries.

An example list of foreign countries, their currency and symbol is listed here. United States dollar USD (US$), Euro EUR (€), Japanese yen JPY (¥), Pound sterling GBP (£), Australian dollar AUD (A$), Canadian dollar CAD (C$), Swiss franc CHF (CHF), Renminbi CNY (¥), Hong Kong dollar HKD (HK$), New Zealand dollar NZD (NZ$), Swedish krona SEK (kr), South Korean won KRW ( [symbol] ), Singapore dollar SGD (S$), Norwegian krone NOK (kr), Mexican peso MXN ($), Indian rupee INR (□), Russian ruble RUB (□), South African rand ZAR (R), Turkish lira TRY (□), Brazilian real BRL (R$), New Taiwan dollar TWD (NT$), Danish krone DKK (kr), Polish [symbol] PLN ( [symbol] ), Thai baht THB ( [symbol] ), Indonesian rupiah IDR (Rp), Hungarian forint HUF (Ft), Czech koruna CZK (Kč), Israeli new shekel ILS ( [symbol] ),Chilean peso CLP (CLP$), Philippine peso PHP ( [symbol] ).

The IOU Platform allows users to connect their bank account or multiple bank accounts if they choose to their IOU Platform account. Banking link is established using industry standards such as user would enter first enter their bank name, routing number and account number and click on submit button to initiate the process. User would then either login into their bank account online (username [some systems email address], and password) to complete verification and link accounts instantly by clicking on agree and link button or can select slower option to link account which consists of IOU Platform or authorized third party depositing 2 small amounts into that user's bank account (example: 0.13 cents, 0.29 cents). User would next have to check that bank account in the next day or two for the amount(s). Next they would log back into their IOU Platform account and enter that amount(s) in the banking link section to establish the connection. User could then transfer funds from their bank account to their IOU Platform account as needed or desired to pay for their IOU credit purchases and or loans received. Likewise this connection allows funds from their IOU Platform account to also be transferred to the banking account as needed or desired. Users can also connect multiple bank accounts to their IOU Platform account if they choose.

### BRIEF DESCRIPTION OF THE DRAWINGS

FIG. 1 is a block diagram of Getting Started and opening an IOU (I Owe You) Account, in accordance with one embodiment of the invention.

FIG. 2 is a screenshot of Getting Started and opening an IOU Account for a Personal Account (individuals), in accordance with another embodiment of the invention.

FIG. 3 is a screenshot of Getting Started and opening an IOU Account for a Business Account (business entities), in accordance with another embodiment of the invention.

FIG. 4 is a screenshot of login page for user to access their IOU Account on the IOU Platform.

FIG. 5 is a screenshot of an IOU Account that has been opened and the view in the account is from the user's perspective, in accordance with another embodiment of the invention.

FIG. 6 is a screenshot of a user wanting to “Send IOU Request or Offer”, where users can search for other users (individuals and businesses), in accordance with another embodiment of the invention.

FIG. 7 is a screenshot of a user wanting to “Request Access”, from an “Individual”, in accordance with another embodiment of the invention.

FIG. 8 is a screenshot of a user wanting to “Request IOU Credit”, from a “Business”, in accordance with another embodiment of the invention.

FIG. 9 is a screenshot view of other user profile once access is granted to business user that requested it from them, in accordance with another embodiment of the invention.

FIG. 10 is a screenshot view of other user additional options once business user that has access clicks on their Set Credit Limit link

FIG. 11 is a screenshot of view of a user IOU Credit Report.

FIG. 12 is a screenshot from the perspective of the user that was given access and with options to “Request or Offer IOU Payment”, in accordance with another embodiment of the invention.

FIG. 13 is a screenshot of an IOU Payment Request or Offer that business user already set defaults for either all users interacting with them or only for some users.

FIG. 14 is a screenshot of a user wanting to “Request Access”, from a “Business” and the tools and profile details that can be accessed with that business user once accepted, in accordance with another embodiment of the invention.

FIG. 15 is a screenshot view of other user profile, once access is granted to individual user that requested it from them, in accordance with another embodiment of the invention.

FIG. 16 is a screenshot of an IOU Loan Request or Offer transaction conducted, in accordance with another embodiment of the invention.

FIG. 17 is a screenshot of IOU Account Settings found in user account, in accordance with another embodiment of the invention.

FIG. 18 is a screenshot of Bank Management and Link features found in user account, in accordance with another embodiment of the invention.

FIG. 19 is a screenshot of Transfer Funds feature, in accordance with another embodiment of the invention.

FIG. 20 is a screenshot of Create My IOU Code feature, in accordance with another embodiment of the invention.

FIG. 21 is a screenshot of View My IOU Code feature, in accordance with another embodiment of the invention.

FIG. 22 is a screenshot of IOU Code scanner feature, in accordance with another embodiment of the invention.

FIG. 23 is a screenshot of an IOU Payment checkout option that can be added to a business user online shopping cart and checkout payment options, in accordance with another embodiment of the invention.

### DETAILED DESCRIPTION OF THE DRAWINGS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

According to one embodiment of the invention, a platform is provided that enables individuals and businesses with the ability to provide credit and pay later and/or lend money to other individuals and businesses using an IOU (I Owe You) form of currency.

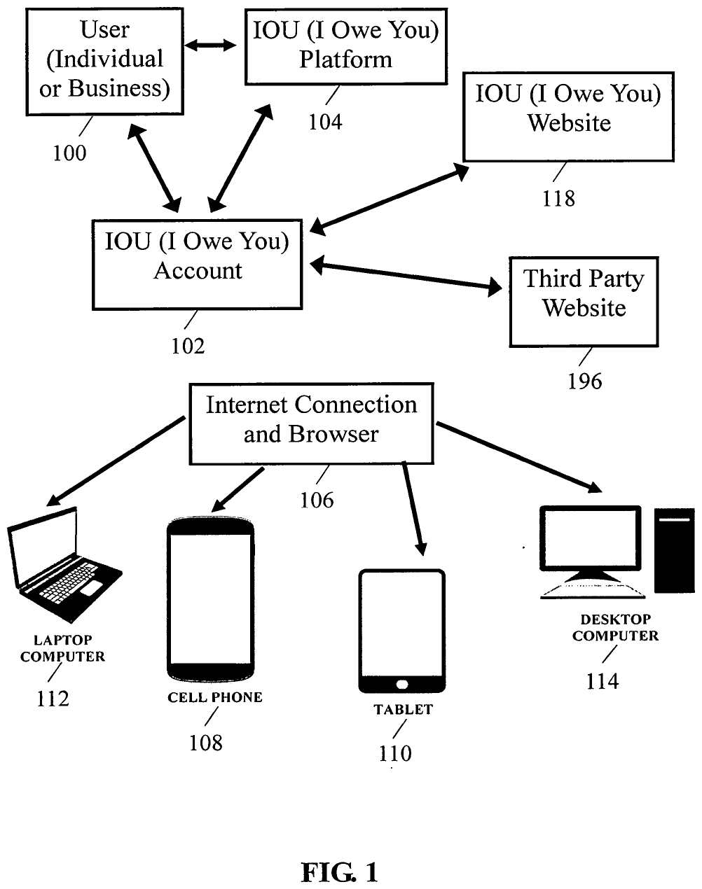

FIG. 1 is a block diagram of Getting Started and opening an IOU (I Owe You) Account 102 (also referred to as account), in accordance with one embodiment of the invention (also referred to as IOU Notes). A user 100 (individual or business) looks to open an IOU (I Owe You) Account 102 from IOU (I Owe You) Platform 104 (also referred to as Platform) and can do so from any device with an Internet connection and browser 106 such as cell phone 108, tablet device 110, laptop computer 112, or desktop computer 114. User 100 can either download the IOU Account 102 application to their device 108, 110, 112, or 114 from internet 106 either by IOU Account website 118 or third party websites 196 or access IOU Account 102 via internet portal 106 from the IOU Account website 118 from any of those devices. All communications, transmissions, customer data, etc. that are processed on IOU Platform regardless of device or method use the industry standard and ongoing practice of security measures, encryption and protection protocols to ensure safety at all time for the platform and its users.

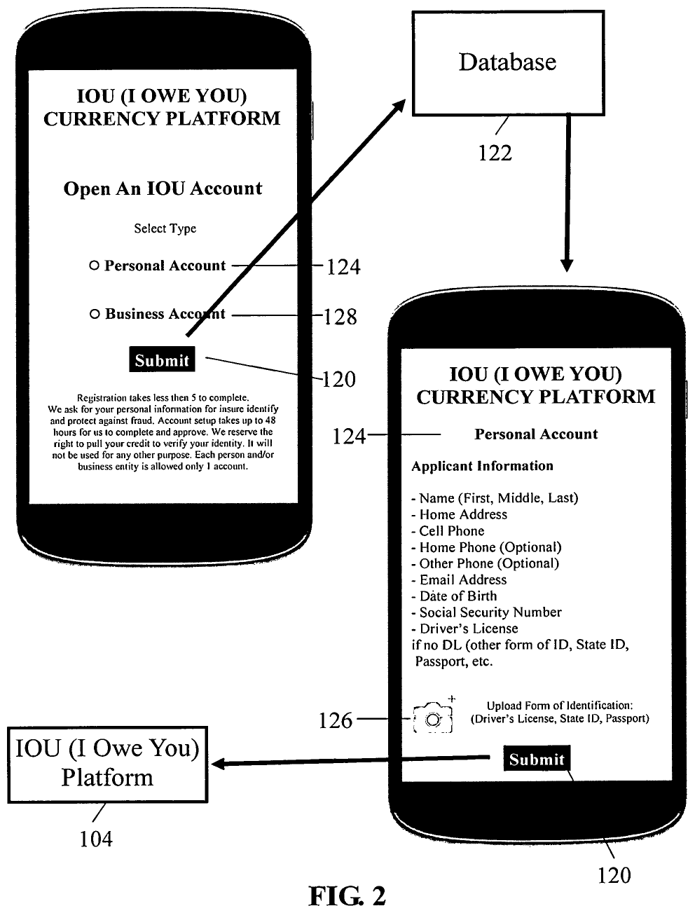

In step 1, FIG. 2 user 100 selects the type of account that they want to open by highlighting the radio button that corresponds to their selection. They can select from a Personal Account 124 (also referred to as individuals or individuals account) or a Business Account 128 (business entities). User 100 would next press the submit button 120. IOU Platform 104 communicates with database 122 via the Internet, and retrieves the correct sign up questions based on user's selection (Personal or Business account). In the example of Personal Account 124, user would be asked for their personal information to submit for review. Example of questions consists of first, middle and last name, home address, cell phone, home phone (if applicable), other phone (if applicable), email address, date of birth, social security number, driver's license number or other applicable form of identification such as state id, passport, etc. User would next upload a copy of their identification using the upload or camera icon 126 on this page. User would next press the submit button 120 as information would be securely sent via encryption (SSL, etc.) to IOU Platform 104 where administration will review the securely submitted information. Using a series of available government and private databases (such as directory listings, credit report, dmv records, etc. it will be determined by IOU Platform 104 reviewers if user 100 is a real person with the proper identification; and they are the person that they say they are. Also if they currently do not have an existing account each user is only allowed one account on the platform 104.

Once a user 100 is accepted to the platform 104 an identify confirmation will be sent to that user's communication method such as a text 184, automated phone call 186, or email 180. Once conformed by the user an account will be created and user can next create their own password for their account which can comprise of alphanumeric characters, special characters, biometric information or combinations thereof.

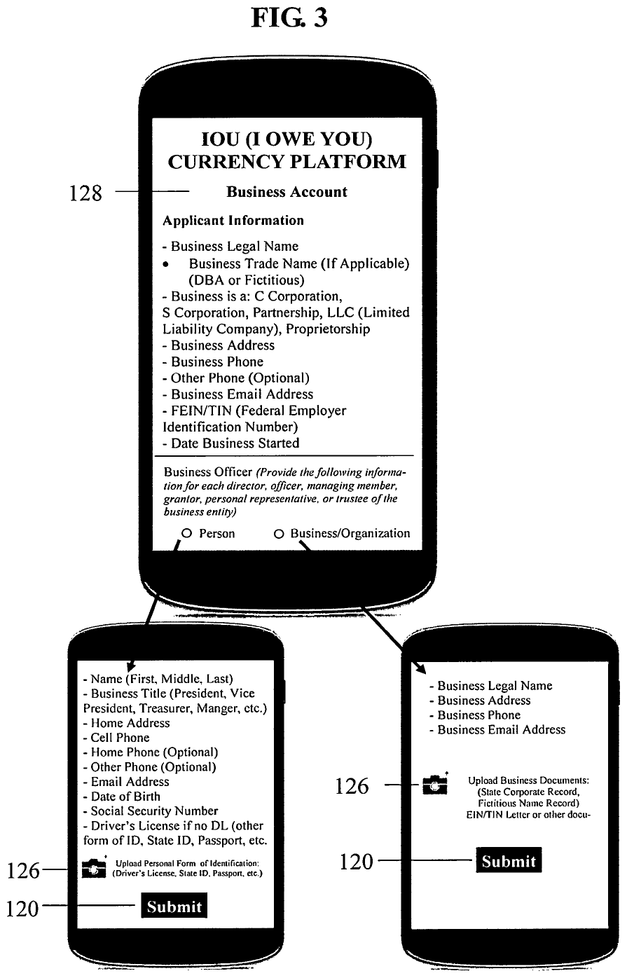

In the example of Business Account 128, FIG. 3, user 100 would be asked for their business information such as business legal name, business trade name (dba or fictitious) (if applicable), entity type (such as c corporation, s corporation, partnership, llc, proprietorship, non-for-profit, etc.), business address, business phone number, other phone number (if applicable), business email address, fein/tin number (federal employer identification). In addition, business officer(s) information would also be needed. If business is controlled by another business entity then the same style of business info would be needed as questions above. If business is controlled by an Individual then corporate officers would also need to submit their personal information for review. Example of questions consists of first, middle and last name, home address, cell phone number, home phone number (if applicable), other phone number (if applicable), email address, date of birth, social security number, driver's license number or other applicable form of identification such as state id, passport, etc. User 100 would next upload their business documents (state corporate record, fictitious record if applicable, ein/tin letter or other documents) and their corporate officer(s) identification document (driver's license, state id, passport, etc.) using the upload or camera icon 126 on this page. User 100 would next press the submit button 120 as information would be securely sent via encryption (SSL, etc.) to IOU Platform 104 where administration will review the securely submitted information. Using a series of available government and private databases (such as directory listings, credit report, dmv records, etc. it will be determined by IOU Platform 104 reviewers if user is a real person with the proper identification; and they are the person that they say they are. Also if they currently do not have an existing account each user is only allowed one account on the platform 104.

Once a user 100 is accepted to the IOU Platform 104 an identify confirmation will be sent to that user's communication method such as a text 184, automated phone call 186, or email 180. Once conformed by the user an account will be created and user can next create their own password for their account.

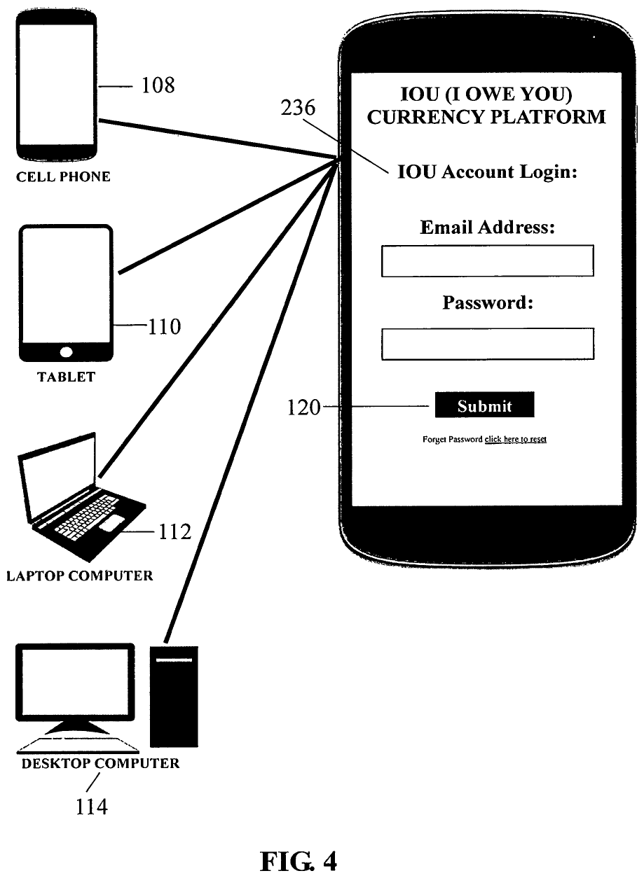

FIG. 4 is a screenshot of an example login page 236 for user 100 to access their IOU Account 102 on the IOU Platform 104 by entering their (email address and password) and selecting the submit button 120. Account Login 236 can be accessed from any device with an Internet connection and browser 106 such as cell phone 108, tablet device 110, laptop computer 112, or desktop computer 114. User 100 can either download the IOU Account 102 application to their device 108, 110, 112, or 114 from internet 106 either by IOU Account website 118 or third party websites 120 or access IOU Account 102 via internet portal 106 from the IOU Account website 118 from any of those devices.

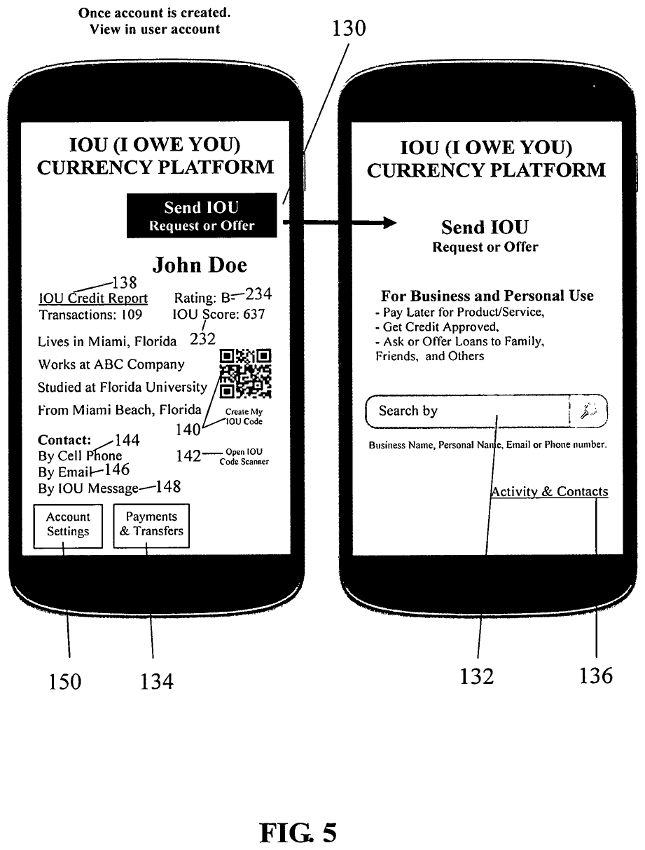

FIG. 5 is a screenshot of an example created account on the IOU Platform 104. User 100 has access to variety of related functions in their account such as, Send IOU Request or Offer 130 which is for Payment and/or Loan requests or offers from user to user, Search 132 for other users (individuals and businesses) on the platform, Make payments and transfers from or to bank account 134, Access activity and contacts 136, Access IOU credit report 138, Create IOU custom code 140, Open IOU code scanner 142, Contact other users by cell phone 144, email 146 or by IOU message 148 in account, and IOU Account Settings 150 (also referred to as Account Settings), such as Account profile 206, Account Security 210, Set Preferences 212 and other related customizable settings and functions.

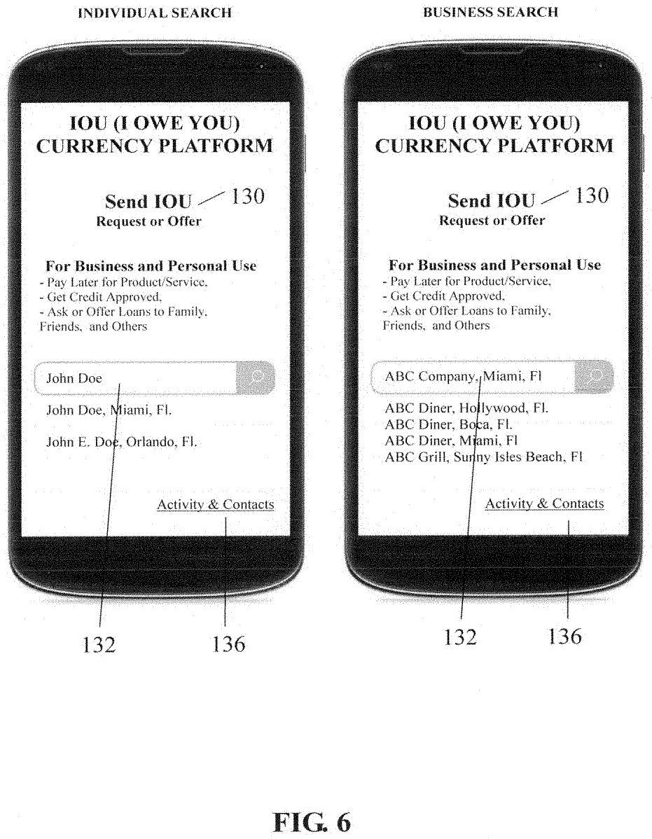

FIG. 6 is a screenshot of an example search function 132 on the IOU Platform 104, where users 100 can search for other users 100 (individuals and businesses). Searches 132 can be conducted by entering business name, personal name, email address, or phone number of the person or entity that is being searched. There is also an activity and contacts 136 feature that users can see everyone that they connected with on the platform 104.

Searches enable users 100 to connect to each other to perform functions such as Pay Later for a product/service that user wants from another user, or offer another user to pay later for product/service offered by that user; Get credit approved with another user that user is requesting it from, or offer credit with other users, or Request loans with another user that user is requesting it from, or offer loans with other users.

If search 132 is conducted and other user 100 that is being searched for does not currently have an account on the IOU Platform 104, user can have platform send other user an invitation by email and or text by having their contacts merged with system or manually entering the other user cell phone number and/or email address.

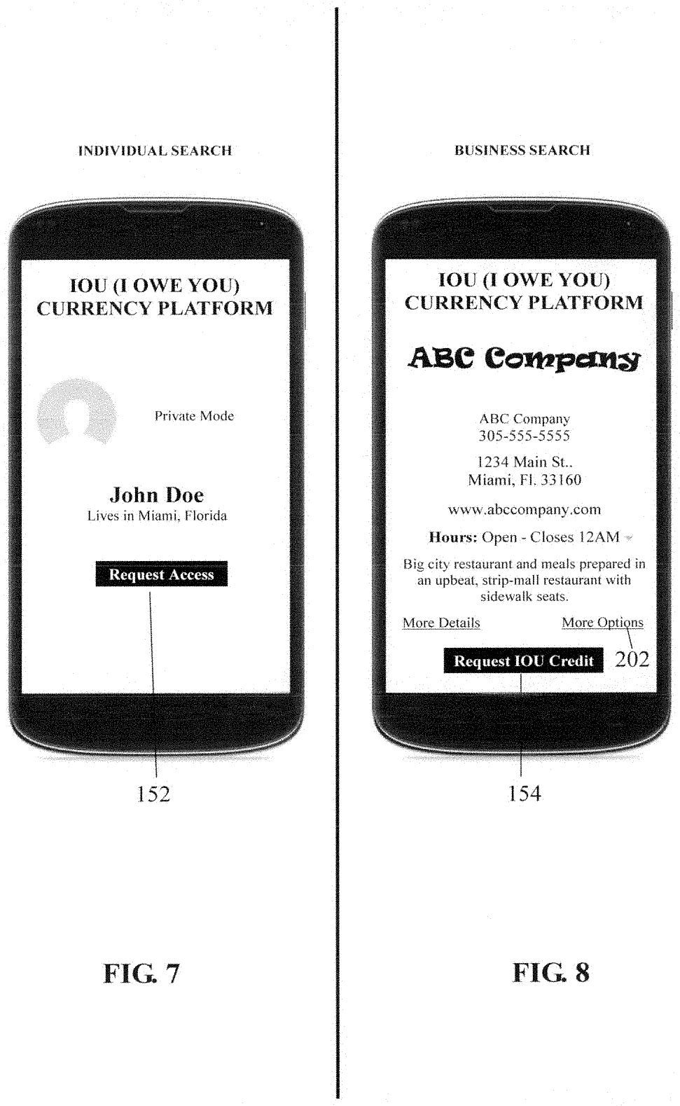

FIG. 7 is a screenshot of an example individual search 132 conducted on the IOU Platform 104. After selected individual is found using one the available methods (personal name, email address, or phone number), user 100 can request access to be able to interactive with that user. To request access user would click on the “Request Access” button 152. The IOU Platform central servers would next receive that request from User A and send request to User B. User that access is requested from will receive by one or by multiple notification methods such as text message 184, email message 180, notification in IOU Account 182, automated phone call 186. User can then accept, deny, or not response to request. If user accepts access from other user, then their account profile could be seen by user that requested it. They will also now also have access to user's account profile that requested access. So request access button works to reciprocally give access to both parties once user that accepts request button.

FIG. 8 is a screenshot of an example business search 132 conducted on the IOU Platform 104. After selected business is found using one the available methods (business name, email address, or phone number), user 100 can request IOU Credit 154 (also referred to as credit) with that business by clicking on button. Unlike individual accounts 124 where a user has to request access first to interactive with that user, for business accounts 128 that is not needed. Business accounts allow anyone to interact with them and request IOU Credit 154 or Send IOU Payment Request or Offer 130. Business users can have all these account features enabled or disable the features that they do not want to offer. They can also enable features for certain users and disable for other users as they see fit for their particular business.

IOU Credit 154 is a pay later internal IOU option that a business user offers to another user that wants to purchase their products and/or services. The IOU platform 104 records these transactions in both users' accounts where transactions take place. The user 100 that received the product or service will have the amount recorded as a liability and all the related details (date, business info, product or service received, terms, etc.) and the user 100 that gave the product or service will have the amount recorded as a future receivable and all the related details (date, business info, product or service received, terms, etc.). When a user requests IOU Credit 154 from a particular business, the IOU Platform 104 sends request to business account holder notifications methods such as text message 184, email message 180, notification in IOU Account 182, or automated phone call 186. Business user can then accept, deny, or not response to request. If user accepts access from other user, they will now have access to user's account profile that requested access where they can view IOU Credit Report 138 (also referred to as credit report or details) and decide if they want to extend credit to this user, if yes, they can decide on the available credit amount to allow, and the other terms such as payment length and interest. IOU Credit Report 138 that can be viewed from other user's profile to help with their decision includes details such as their name, date joined on IOU Platform, number of transactions, IOU Score 232, IOU Credit limit from other businesses, number of vendors that have credit with, Payment history, any IOU Loans received, given, if applicable, and their IOU Overall Rating and Grade 234. Details are not limited to these examples provided.

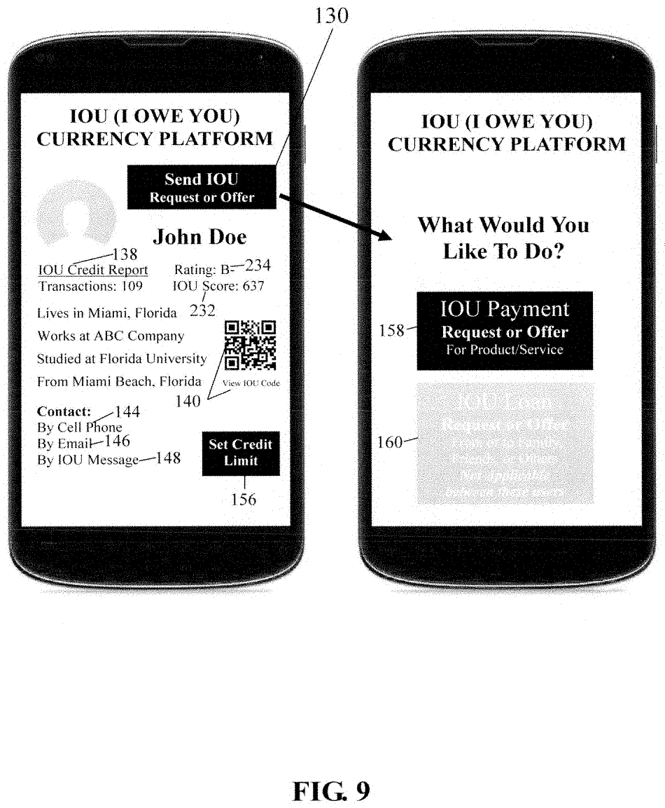

FIG. 9 is a screenshot of an example view of other user 100 profile once access is granted to business user that requested it from them. That other user 100 can check out profile details (user's decide which info to share with others) such as where other user lives, works, studied, hometown, IOU Credit Report 138, Contact methods, Custom Code 140, Send IOU Request or Offers 130 (Payments and/or Loans), Set Credit Limit (if applicable for that user), etc. If business user did not want to offer IOU Loans 160 (also referred to as loans) to other users then this feature would not be applicable in that interaction and not featured in account between those users. Once a user already 100 has a working line of IOU Credit 154 from a particular business user 100 then they can send IOU Payment Request or Offer 158 (also referred to as payment) to them. Business user has to have this feature enabled in their account to allow. Some businesses would disable this feature in their account because they would rather prefer a one way method of transactions. For example in a one way transaction, user wants to buy a product or service from the business. In an example of a shoe store, user goes into store, tries on and finds a pair that they like and with any other items goes to the cash register to pay for shoes. Cashier scans the items and total is calculated and user can pay with their preferred acceptable payment method. In a one way transaction, user has to wait to pay for the items when cashier is ready. A one way transaction with the IOU Platform 104 would look as follows. Using the shoe store example, when time came at the cashier to pay user 100 could request to pay using their IOU Account 102. If business accepted this method cashier would have their IOU Account open, and can either scan in other user's Custom IOU Code 140 from user's phone or enter their name, phone number, or email account to locate their account. Before user can use IOU Account with that business they would have to request IOU Credit 154 in advance for them to have credits funds to work with and give business user access to their account details. In the example of scanning a custom IOU code 140, business user would open their connected IOU Account device such as a tablet device 110 or cell phone 108 (connected to Internet), open the page in their IOU account 102 with IOU Code camera scanning 142 feature and place near other user's IOU custom code 140. User's account would come up and show their details and available IOU credit 168. Then business user could add the details and submit to get accepted by other user. IOU platform sends payment transaction to other user such as text message 184, email message 180, notification in IOU Account 182, automated phone call 186. User views the transaction and if correct confirms the purchase to complete the transaction.

The above example illustrated a one way transaction, where a business who is selling the product or service to the user must be the one to initiate the transaction (cash register, ask for payment, send invoice, etc.). Most transactions made in person in the economy are examples of one way transactions. In online transactions between businesses and users these are two transactions where users can use automated methods such as shopping carts, make payment buttons, etc. to initiate the transaction. The IOU Platform 104 offers one way and two way transactions in the form of the send IOU Payment Request or Offer 158 feature. A business can use send IOU Payment Request 164 to request pay later option for their product or service from a user. If they enable the two way feature, then sending IOU Payment Offer 166 allows users to send pay later offer to the business that they are receiving the product or service from.

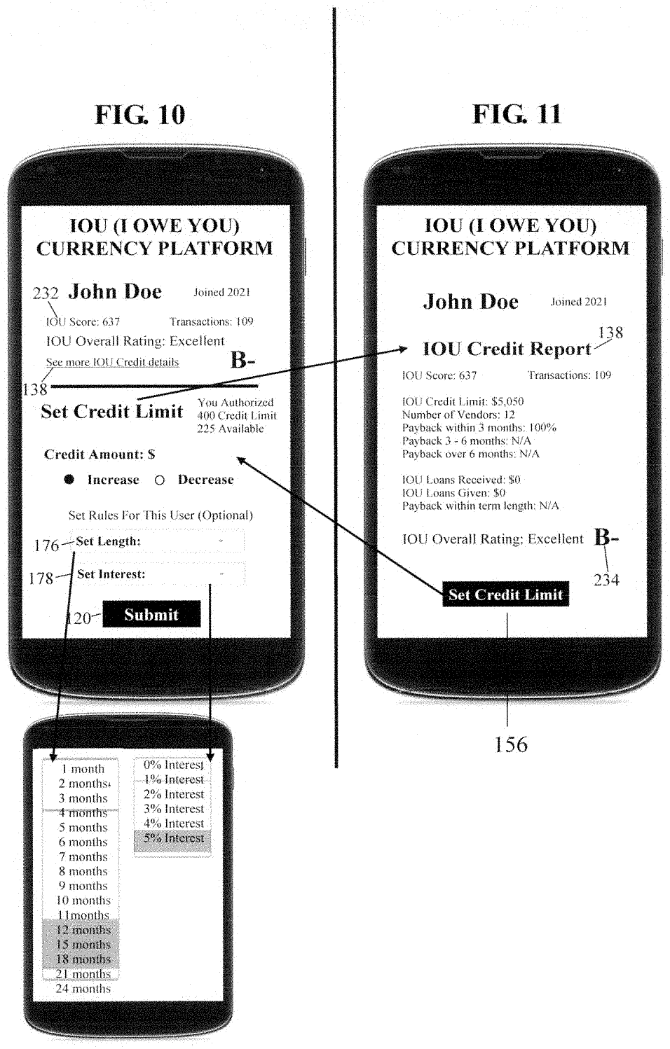

FIG. 10 is a screenshot of an example view of other user profile once business user 100 that has access clicks on their Set Credit Limit link 156. If user 100 is a business account and viewing another user's profile, that business can extend IOU Credit 154 to that user for the first time; Increase or Decrease IOU Credit at anytime; set optional rules for this user such as Credit Payback Length (1-24 months), and Set Interest Terms (0%-5%) charged past initial 30 days period by selecting the corresponding radio buttons, dropdown menus, and entering the submit button to make the changes. Set Credit Limit 156 can also be accessed from IOU Credit Details 138 for that user that is viewed.

FIG. 11 is a screenshot of an example view of user's IOU Credit Details 138 which includes information such as their name, year joined the platform, IOU Score 232, Number of Transactions, IOU Credit Limit (from all their vendors) and also from this vendor viewing profile (both credit limit and amount used), Number of Vendors have transactions with, Payback data such as within 3 months, 3-6 months, over 6 months, IOU Loans received, given, and payback within term length, and overall IOU Overall Rating Grade.

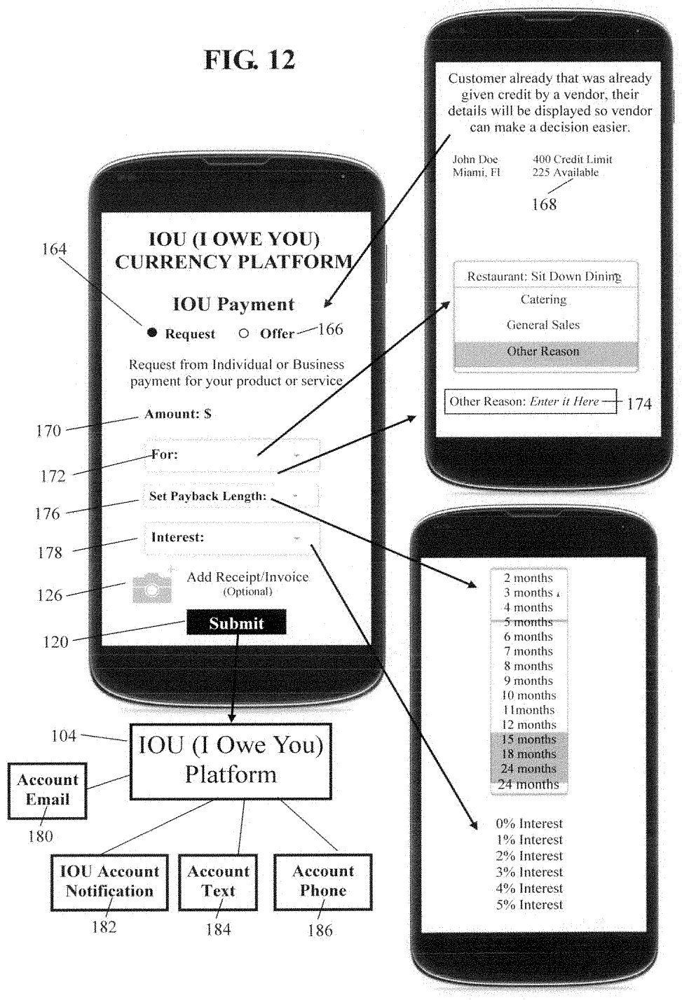

FIG. 12 is a screenshot of an example IOU Payment Request or Offer 158 conducted on the IOU Platform 104. User 100 selects from the radio buttons to either make an IOU Payment Request 164 (request from other user payment for the product or service that they received or will receive) or Offer 166 (offer to other user payment for the product or service that user requesting offer received or will receive). Next user would enter the amount of the transaction total 170 for the product or service. Then user would select from the dropdown menu what transaction reason 172 is for from a long list of choices generated and stored in the platform (user can save there own custom entered choices also for future use). If other reason was selected from dropdown menu for transaction type, then platform would insert text box 174 into screen from the platform so custom words could be added for that transaction. Next user would set the terms, these include payback length 176 (for example, 1-24 months) and if there is going to be interest charged past the initial 30 day. If yes, at what interest rate 178 will this be set to (For example, 0%-5%). Then if user 100 wants to include a receipt, invoice, or other item to include in the payment transaction record there is a camera icon 126 that can be clicked. If clicked user can take photo or attach file from their device. After all IOU Payment 158 details are entered, user submits request by clicking on the submit button 120. The IOU Platform 104 central servers would next receive that request from User A and send request to User B by the email 180 from the one on file and also as a notification in their IOU Account 182. Other methods that platform could also send notifications to requested user is also by text messages 184 and automated phone calls 186. Once User B accepts payment request or offer, transaction details (date, business info, product or service received, terms, etc.) gets recorded in both User A and User B accounts. The user that received the product or service will have the amount recorded as a liability and the user that gave the product or service will have the amount as a future receivable In the event that if one user does not accept or declines the request or offer then the transaction does not take place and does not get recorded and posted to each other's account.

The IOU Platform 104 requires both parties of the transaction to be involved and user 100 making the payment to accept and confirm the transaction. This requirement adds an extra layer of protection against mistakes, fraud, and other related issues. A problem with any currency is to make the transaction to go as easily as possible from start to finish. In the credit card industry the standard at one time in the past was the person presents the card in person with the proper id to make sure the name on the card matched to prevent unauthorized use. Over time the credit card industry got more relaxed, with the growing availability of technology and with less restrictions placed. Credit cards and other forms of payments sales can now be done over the phone, internet, and mobile apps. In these transactions anyone with access to the credit card details, etc. can place and make the purchase. Each year these companies have a large number of fraud cases because there is fewer requirements to verify that owner of those payment methods authorized the purchase. In a typical scenario with the IOU Platform 104 both parties are have to confirm the purchase (buyer and seller) or loan (lender or borrower). If other user 100 does not accept or declines the request or offer then the transaction does not take place and does not get recorded and posted to each other's account. In the case of an IOU Loan 160, funds do not get sent until other user accepts. This added confirmation reduces the likely of mistakes, fraud, and other related issues.

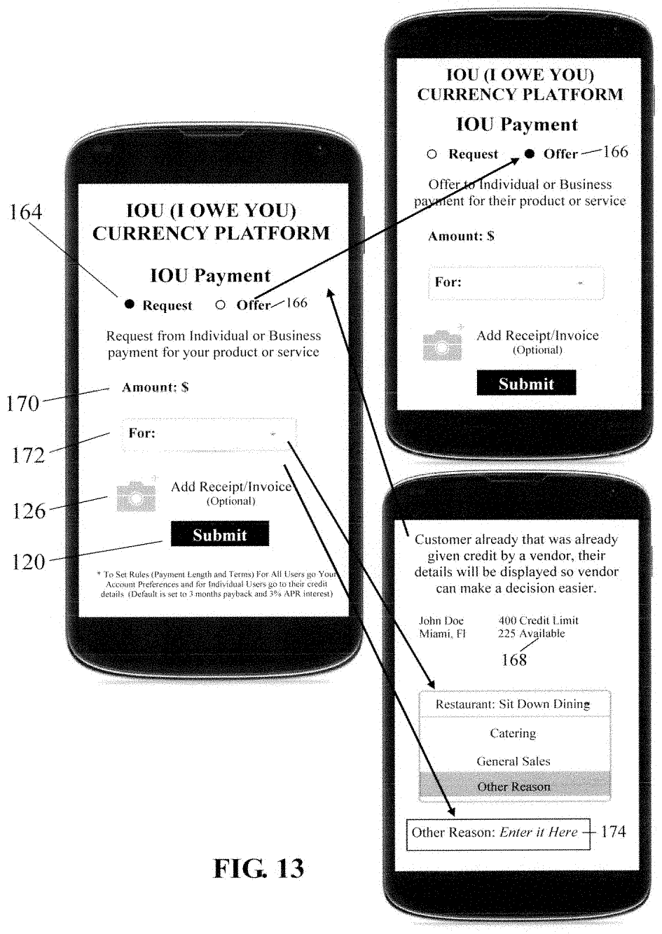

FIG. 13 is a screenshot of an example IOU Payment Request or Offer 158 conducted on the IOU Platform 104 that business user already set in their Account Settings 150 and set the terms, these include defaults for payback length 176 and interest rate 178 for either all users interacting with them or only for some users. In this scenario transaction could be conducted faster since some questions are already setup by default. User's default will appear on screen during transaction so other user could see all the transaction terms.

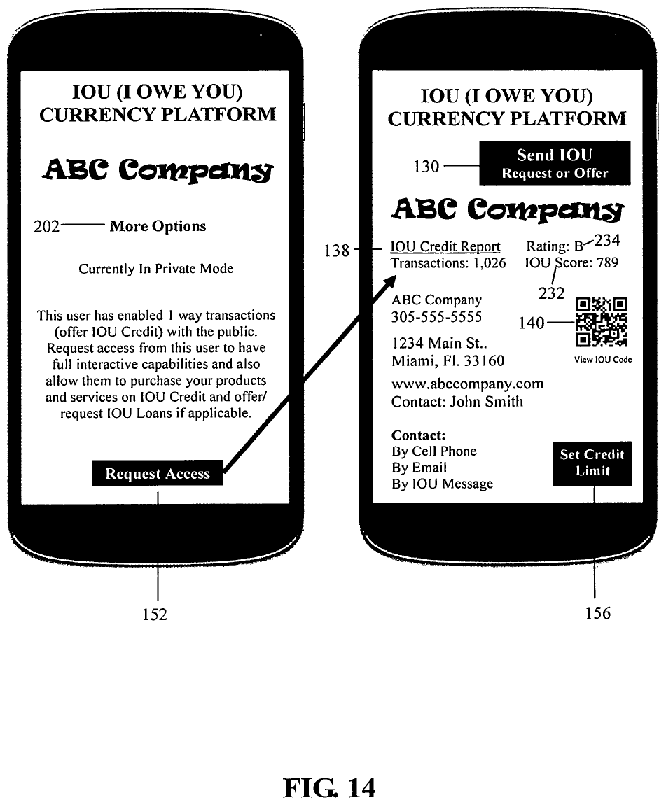

FIG. 14 is a screenshot of an example view of “More Options” 202 link on Business User Profile. Default setting is that when a user 100 searches for a business user 100 and finds that business they have access to view that business's standard profile which includes Entity name, address, phone number, website address, about company products and services and other related info. Default transactions that are offered to other users are the ability to buy products and/or services from this user and to request IOU Credit 154. Business users are also potential customers to other businesses on the IOU Platform 104 and can also activate the request and offer payment and loan features for their account. In more options, each business user decide which other users 100 (Individual and Business) on the IOU Platform will be able to view their business IOU Credit Report 138 and also request and offer IOU Payments 158 and IOU Loans 160 with them. To request access user would click on the “Request Access” button 152. The IOU Platform central servers would next receive that request from User A and send request to User B by the email 180 from the one on file and also as a notification in their IOU Account 102. Other methods that platform could also send notifications to requested user is also by text messages 184 and automated phone calls 186. User can then accept, deny, or not response to request. If user accepts access from other user, then their account profile could be seen by user that requested it. They will also now also have access to user's account profile that requested access. So request access button works to reciprocally give access to both parties once user that accepts request button. The platform also adds this request in both accounts in the account Activity 136 of the user that requested access and the user that it was requested from so the outcome of requested access can be tracked and access granted if accepted.

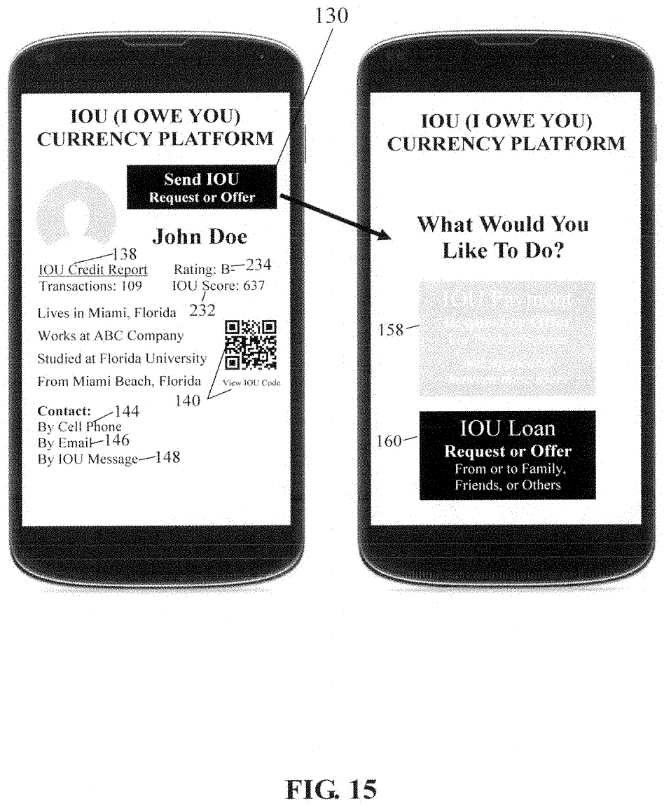

FIG. 15 is a screenshot of an example view of other user profile once access is granted to individual user 100 that requested it from them. If interaction was individual user to another individual user and this feature was disabled by one of the users then Set Credit Limit feature 156 would not be applicable in that interaction and not featured in account between those users. In addition, IOU Payment Request or Offer 158 would also not appear in interactions between individual user to another individual user, if IOU Payment was disabled by user in their account. There are many situations where Individuals would like to extend credit between themselves and another user and offer this payment method. Examples of these transactions include selling personal property (used cars, furniture, garage sales, etc.) or other forms of transactions such as rent payments, down payments, etc.

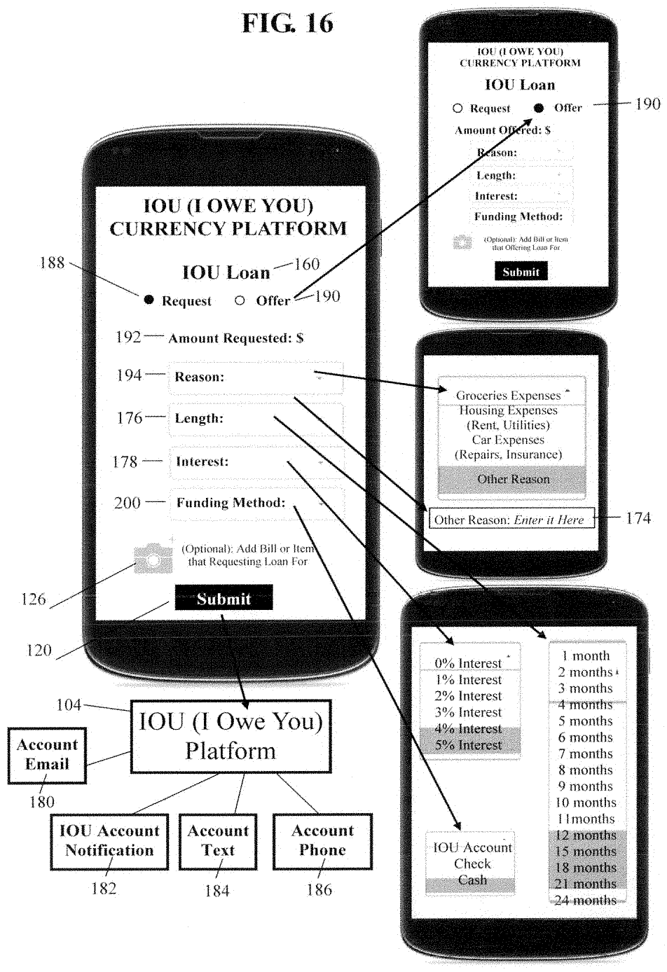

FIG. 16 is a screenshot of an example IOU Loan Request or Offer 160 conducted on the IOU Platform 104. User 100 selects from the radio buttons to either make an IOU Loan Request 188 (request from other user a loan for needed help) or Offer 190 (offer to other user a loan for needed help). Next user would enter the amount of the loan total 192 requested or offered. Then user 100 would select from the dropdown menu the loan reason 194 from a long list of choices generated and stored in the platform (user can save their own custom entered choices also for future use). If other reason was selected from dropdown menu for loan reason, then platform would insert text box 174 into screen from the system so custom words could be added for that transaction. Next user would set the terms, these include loan length 176 (for example, 1-24 months) and if there is going to be interest charged past the initial 30 day. If yes, at what interest rate 178 will this be set to (For example, 0%-5%). Then set the funding method 200, which includes either default method of transferring funds from IOU Account 102 or offline method Cash or Check. If user selects either Cash or Check, the IOU Platform 104 will still have all the transaction details but since the Cash or Check transfer will not take place on the IOU Platform it is up to both users to verify that loans funds where given or received. In this scenario users would have to verify in their account that they received/transferred loan funds and then when loan was paid so transaction will be closed on the IOU Platform and also in both users accounts. If a user received or transferred loan funds using an offline method (cash, check), the other user can decide to pay back using transfer from IOU Account 102. This can also take place vice versa, Initial transfer from IOU Account and get paid back by offline method (cash, check). Transactions funds can also stay entirely online by IOU Account or entirely offline (cash, check). If transfer or repayment of loan is paid from IOU Account then the platform will automatically transfer payment(s) and close out the transaction. Users can specify in their account if they want to offer or receive loans and if yes which funding methods they will allow. Next if user wants to include a receipt, invoice, or other item to include in the loan transaction record there is a camera icon 126 that can be clicked. If clicked user can take photo or attach file from their device. After all IOU Loan details are entered, user submits request by clicking on the submit button 120. The IOU Platform 104 central servers would next receive that request from User A and send request to User B by the email 180 from the one on file and also as a notification in their IOU Account 182. Other methods that platform could also send notifications to requested user is also by text messages 184 and automated phone calls 186. Once User B accepts loan request or offer, transaction details (date, user info, loan amount, reason, length, terms, funding method, etc.) gets recorded in both User A and User B accounts. The user that received the loan will have the amount recorded as a liability and the user that gave the loan will have the amount as a future receivable. In the event that if one user does not accept or declines the request or offer then the transaction does not take place and does not get recorded and posted to each other's account.

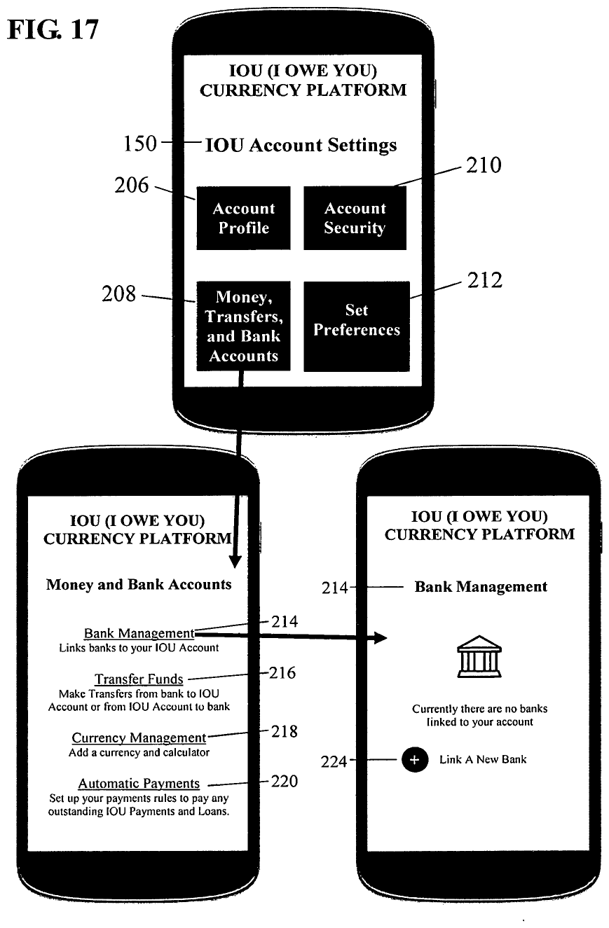

FIG. 17 is a screenshot of an example view of a user 100 IOU Account Settings 150. User's can view and modify info in their IOU Account 102 such as account profile 206, account security 210, set preferences 212, money, transfers, bank accounts, and other related settings 208. Account Profile 206 settings include personal info, business info (if applicable), etc. Account Security 210 settings include change password, security questions, etc. Set Preferences 212 settings include preferred language, time zone, set payments length, terms, and other related functions. Money, transfers, bank accounts and other related settings 208 include link bank accounts 214 to IOU Account 102, make transfers from bank to IOU Account or vice versa 216, currency converter and currency calculator 218, setup automatic payments 220 and payment rules for IOU Payments 158 and IOU Loans 160, etc.

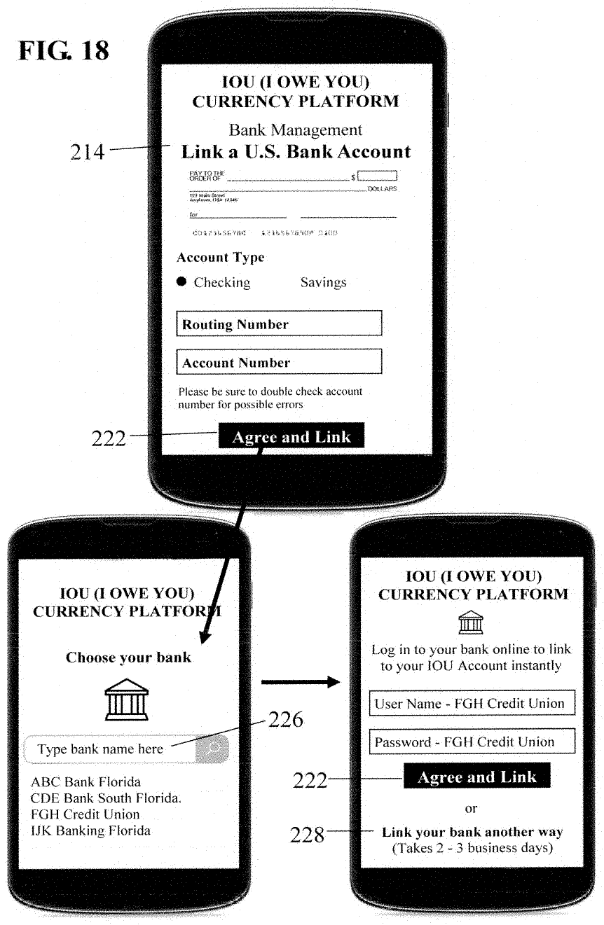

FIG. 18 is a screenshot of an example view of the Bank Management 214 option in IOU Account Settings 150. This option allows user 100 to link bank accounts to their IOU Account 102. Once linked, user 100 can make transfers from their bank to IOU Account 102 or vice versa. In order for users to start requesting IOU Credit or Loans from other users and using that credit or loan, a bank account must be linked so users can pay back funds owed later. To add a new bank to IOU Account user would select Bank Management 214 link in account settings. Next link a new bank option 224 would be selected and user would enter bank's name in search function 226. Once that name is found they would select it and on next screen enter the routing number and account number that they want to add and click on agree and link button 222 to submit request. User would then either login into their bank account online (username [some systems email address], and password) to complete verification and link accounts instantly by clicking on agree and link button 222 or can select slower option to link account which consists of IOU Platform or authorized third party 228 depositing 2 small amounts into bank account (example: 0.13 cents, 0.29 cents). User would then check their bank account in 2-3 business days for the exact amounts and come back to their IOU Account to enter those amounts to establish the linking of account. If users want to add multiple bank accounts to same IOU Account then they would duplicate the verification process for each new bank account that they want added.

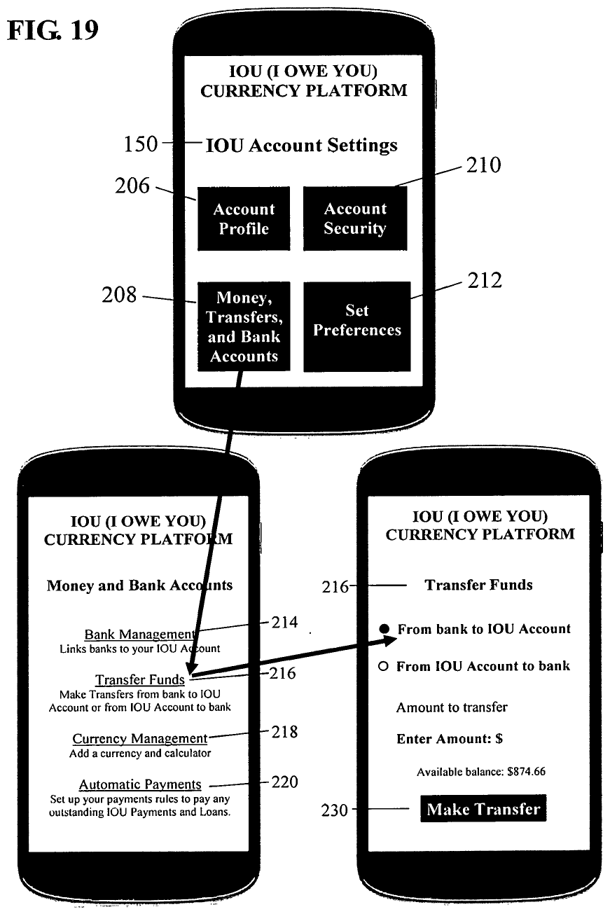

FIG. 19 is a screenshot of an example view of the Transfer Funds 216 option in Account Settings 150. This option allows user 100 to transfer funds from their link bank accounts to their IOU Account 102 or vice versa. To make a transfer user would click on Transfer Funds 216 link option in Money, Transfers, and Bank Accounts section 208 of their IOU Account Settings 204. Next user would select from radio buttons to either transfer funds from bank to IOU Account or from IOU Account to bank. Next user would enter the amount to transfer and complete transaction by clicking on the Make Transfer button 230. If user has more then one bank account linked to IOU Account system would allow user to select which bank to select before making the transfer.

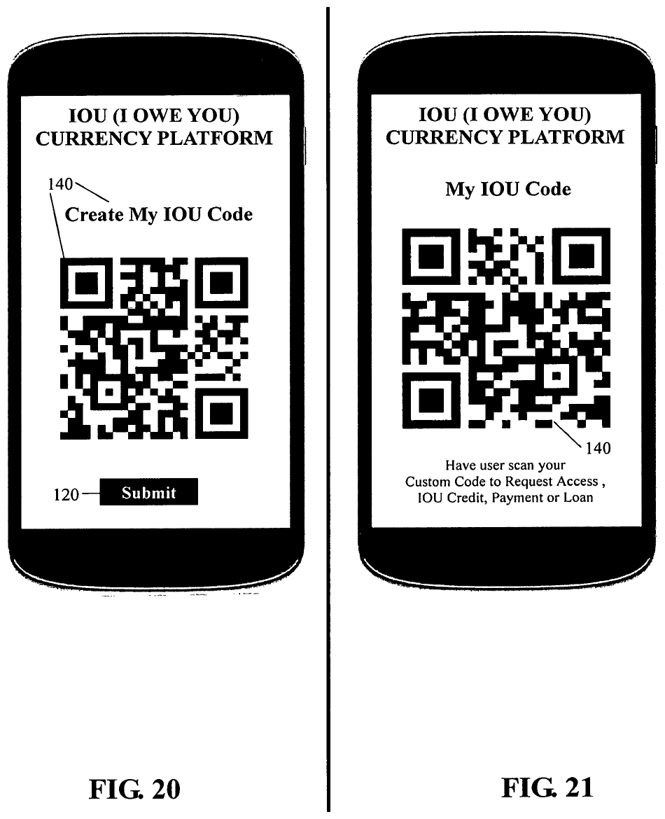

FIG. 20 is a screenshot of an example of the custom IOU Code 140 creation tool in each user 100 IOU Account 102. Each user 100 on the IOU Platform 104 has the opportunity to create their custom IOU Code 140 and that code will be linked to their IOU Account. The IOU Code is an alternative to the search feature 132 in the IOU Platform 104 where users have to enter personal or business name, phone number, or email address to locate other user on the IOU Platform. Once a custom IOU Code is created for a user they can allow other users to scan their IOU Code and request and/or offer payments, credit, or loans to them.

FIG. 21 is a screenshot of an example view of a custom IOU Code 140 generated by the IOU Platform 104. Each user 100 on the IOU Platform has the opportunity to create their custom code and that code will be linked to their IOU Account 102. These codes can then be used when wanting other user to request access 152, IOU Credit 154, IOU Payment 158 or IOU Loan 160. For example, User A goes into a retail store, selects a few items and at checkout requests to pay by IOU Credit 154. If store accepts IOU Credit and user already requested credit from store in advance and has IOU Credit available then this transaction can take place. At checkout, store cashier would open their IOU Account (such as from tablet device 110, or cell phone 108), go to IOU Code Scanner 142 feature, press on camera icon and place over other user's IOU Code 140. User's account would come up, where store cashier can send IOU Payment 158 request with details to user making the purchase. After entering all the transaction details and clicking on the submit button 120, the platform would send (example: email 180, IOU Account Notification 182, text 184, automated phone call 186) transaction request to user to confirm and accept. Once accepted transaction is complete. User making purchase gets product or service and can pay later, and business selling product or service gets IOU that will get paid later by other user. All transaction details are recorded on the IOU Platform and in the users account. The IOU Code is an alternative to the search feature 132 in the platform where users have to enter personal or business name, phone number, or email address to locate the user on the platform.

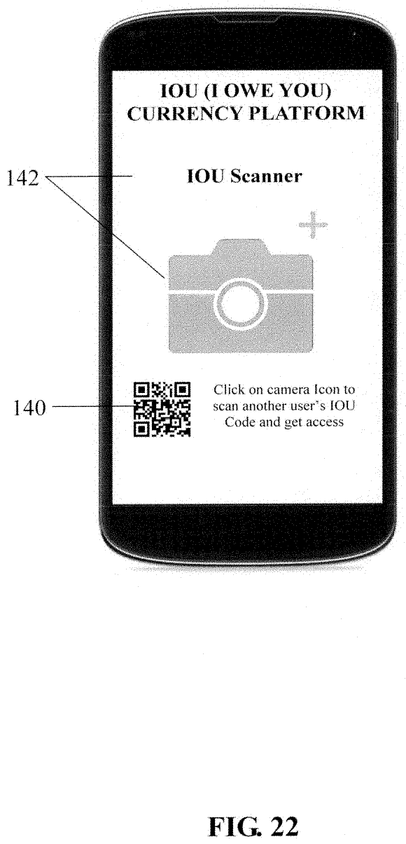

FIG. 22 is a screenshot of an example of the custom IOU Code scanner 142 in each user 100 IOU Account 102. Each user 100 on the IOU Platform 104 has a scanner 142 feature to scan other user's IOU Code 140 to connect to that user faster. Once IOU code is scanned, user can request and/or offer payments, credit, or loans to that other user. The IOU Code is an alternative to the search feature 132 in the IOU Platform 104 where users have to enter personal or business name, phone number, or email address to locate the user on the platform.

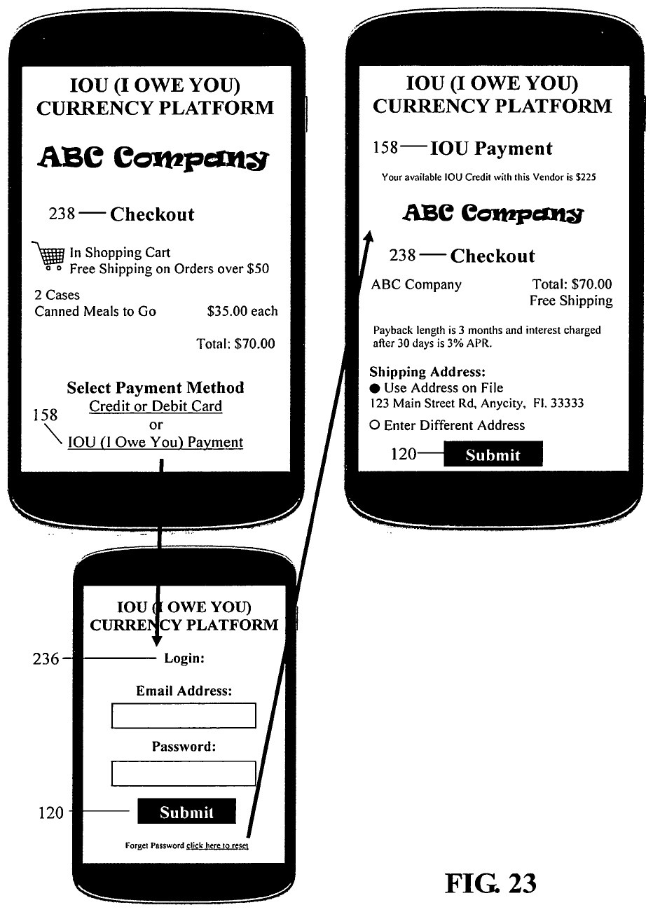

FIG. 23 is a screenshot of an example view of an IOU Payment 158 checkout option that can be added to a business's online shopping cart and checkout 238 payment options. Online shopping carts all work generally the same. User goes to a particular business website, finds a product that they like and adds it to that website's online shopping cart and specifies the quantity of that item. Then continues to shop online and buy other products offered by that business in the same manner or is done with shopping and selects to go to checkout to pay. Once user specifies to pay, they would next select their payment method. Common options offered by businesses include credit cards, debit cards, and electronic checks. With the IOU Platform 104, a business can add IOU Payment 158 option and at checkout 238 when user 100 is presented with select payment method they can click on IOU Payment 158 option link. Next user 100 would be redirected to IOU Platform login page 236 where they would login 236 into their IOU Account 102 (email address and password) and select the submit button 120. Once logged in users 100 would see order details with that business (items ordered, amount, etc.), their preferred shipping method or they can enter a new delivery address for this order. If user already has available IOU Credit 154 with that particular business this page would also list that here. If no credit has been requested and is not established with that particular business then user can request it now but will not be able to finish this transaction with IOU Payment 158 until business grants them IOU Credit 154 greater then the amount of the product total that they want to purchase. If user puts in a request credit, then afterwards they will be returned to other payment options offered by that business to finish transaction if they want.

The present invention was described in detail with reference to the drawings, which are provided as illustrative examples of the invention so as to enable those skilled in the art to practice the invention. Notably, the figures and examples above are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention were described, and detailed descriptions of other portions of such known components were omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. It should be understood that the various functions and sequence of steps described above and attributed to the platform have been provided only for the purposes of clarity and that some of these functions and steps can be performed by multiple elements and multiple systems. The steps for performing a transaction may also be performed in a different sequence. In addition, while the above description refers to get loan and/or product and/or service and pay later with an IOU (I Owe You) form of currency, the invention it not limited to any particular County's (example: US Dollar) form of currency. Transactions can be conducted in any currency. Further, the present invention encompasses present and future known equivalents to the known components referred to herein by way of illustration.

What is claimed is:

1. A system and method that provides users with a computer implemented platform with the ability to facilitate an IOU (I Owe You) transaction with other users.
receiving a request from a potential user to register with a platform;
acquiring first personal and contact related information from the potential user;
determining and going through verification process as determined by the platform;
thereafter allowing the potential user access to the platform if the potential user passes the verification process and denying access to the platform if the potential user does not pass verification process;
receiving a request from a user to search for other users on the platform;
thereafter allowing the user to send IOU (I Owe You) transaction details to other user to either accept or deny the terms of the transaction;
thereafter if transaction is successful, generating transaction details in both users account such as amount, reason, term length, and interest;

2. The method of claim 1, further comprising:
acquiring second information about the potential user based on type of account that they want to register as and interact with the platform either as an individual, business, or institution;

3. The method of claim 1, further comprising:
determining and going through verification process to verify that user is in fact a real person, or business entity, and that person, or business entity, is if fact who they say they are;
thereafter allowing the potential user access to the platform if the potential user passes the verification process and denying access to the platform if the potential user does not pass verification process such as not being a real person, or business, having an account already, missing required information and documents needed for verification process, or other related reasons according to the predetermined system standards;

4. The method of claim 1, further comprising:
receiving a request from a user to search for other users on the platform; such as personal name, email address, or phone number for individual users, and business name, address, or phone number for business users;
thereafter generating a notification to other user on platform that initial user wants to connect and request access to interact with them on platform;
thereafter allowing the requested user to accept or deny access to interact with the other user that requested it;
whereas if other user that is being searched for does not currently have an account on the platform, user can have platform send other user an invitation by email and or text by having their contacts merged with platform or manually entering the other user cell phone number and or email address;

5. The method of claim 1, further comprising:
receiving a request from a user to another user for a request of IOU (I Owe You) Credit;
whereas that requested user will be given access to view other user's IOU (I Owe You) Credit details which include information such as year joined, system IOU (I Owe You) Score, numbers of transactions, combined credit limit from other users, number of vendors, payback history, loans received or given, overall rating, etc. and determine if they want to extend IOU (I Owe You) Credit to other user and their terms such as credit amount, repayment length, and interest rate;

6. The method of claim 1, further comprising:
thereafter allowing the user to send IOU (I Owe You) requests or offers to other users, such as IOU (I Owe You) Payments for receiving products/services now and paying later or IOU (I Owe You) Loans for receiving loans now and paying later;
whereas user can and establish terms of the transaction, such as amount, repayment length, and interest rate;
furthermore where user can use platform built in camera or file upload to attach photos of transaction documents such as receipt, invoice, etc. for record keeping so both users of can access in their account later;
thereafter receiving a request from a user to send transaction details to other user, by email, in an IOU (I Owe You) account notification, and text messages, to either accept or deny the terms of the transaction;
whereas transactions are directly from user to user and not based on getting approval first from any banking, credit card, financial institution, or government agency, or based on users traditional credit history report, income, tax returns, or collateral needed;

7. The method of claim 1, further comprising:
thereafter if transaction is successful, generating transaction details in both users account such as amount, reason, term length, and recording the associated accounting of debits and credits in user accounts;
whereas users link their bank account with their IOU (I Owe You) account to be able to transfer funds to their account and pay back other users directly that are owned either by or before due dates;
whereas the link to users bank account is fully complaint with financial regulations and laws and has one or more security validation measures for establishing link and transferring money between users banks and the platform;
whereas users will get alerts by email and in their IOU (I Owe You) account for transactions that upcoming and due soon;
whereas users if they need more time on payments that are owed to other users can use system tools to ask them for more time which other user can either accept or deny the request;

8. A system and method that provides users with a platform to create and generate new money activity into the economy with an IOU (I Owe You) alternative form of currency;
whereas a user interface that can be accessed by any device such as cellular phone, tablet device, laptop computer, or desktop computer with an Internet connection and browser;
receiving, by the central platform computer, a request to find another user by entering the related search such as other user's personal or business name (if applicable), email address, or phone number;
whereas the central platform computers searches it's own database and pulls up the closest to user's entered search;
whereas users can interact with each other and approve the type of transactions that they will allow between each other, the term lengths that they will allow, and the interest rates that will be charged;
whereas payments owed between users will have to be paid directly back to that user on the platform;

9. The method of claim 8, further comprising:
whereas users can extend or request credit and/or loans directly to or from other users and setup all transaction terms such as credit limit, loan limit, payback length, interest rate, etc. are agreed and determined directly between the two users and facilitated on the platform, which is user to user and not based on getting approval from by any banking, credit card, financial institution, or government agency, or based on users traditional credit history report, income, tax returns, or collateral needed;

10. The method of claim 8, further comprising:
whereas when a user wants to purchase products/services from another user on credit, the system would send a request to that user;
whereas if request is new one, user can determine if they want to interact with that other user and extend or deny to them a credit limit;
whereas, if credit limit is granted then user can purchase products/services from that user up to the credit limit granted and pay later based on the agreed upon terms;
whereas each user will determine if, when, and which users to raise credit limits;
whereas each user will be able to access other users that they interact with their related IOU (I Owe You) Credit details such as year joined, system IOU (I Owe You) Score, numbers of transactions, combined credit limit from other users, number of vendors, payback history, loans received or given, overall rating, etc. that they work with to make important informed financial decisions on weather to extend credit, how much, and the terms;

11. The method of claim 8, further comprising:
whereas users link their bank account to system and then can transfer funds from their bank account to their IOU (I Owe You) account and then can pay back other users directly that are owned money either by or before due dates;
whereas if payments are not made by user to other users on the system for the amounts that they owed and are past due dates, system will automatically put hold on account until it is brought in good standing by paying those outstanding debts;
whereas system offers an alternative option that users can pay back other users funds owned in person if they choose with cash or check but must remember to mark that transaction manually in their account so system will sent updated request to other user and they can accept to post the details in both accounts;

12. The method of claim 8, further comprising:
whereas transactions are conducted in that user's particular county form of currency. (example: If US account then form of currency will be US Dollar); transactions can be conducted in any currency by using system currency conversation tools;

13. The method of claim 8, further comprising:
allowing all users to create and generate new money activity into the economy through the use of granting loans or extending credit to other users which are new loans to other users to use as needed or credit to buy their product or service;
whereas each time a new loan or extending credit or raising credit limit is made to another user (borrower) new money is created in the economy with that loan or when user uses the credit;
whereas the platform extends money creation and generating new money into the economy abilities to all people and businesses in every country regardless of their background, gender, race, religion, political affiliation, economic status, education, income level, or any other factors that people use to create differences;
whereas the platform takes the established practice of businesses providing service first and then getting paid later (15 minutes, 30 minutes, 1 hour, or 2 hours, etc. later when customer leaves from place of business or service has been provided) and extends it for a longer pay later option which also includes product based businesses and individuals operating as sole proprietorships;

14. The method of claim 9, further comprising:
whereas the IOU (I Owe You) platform has its own IOU Credit Score that users can utilize to evaluate others credit and loan worthiness and decide to do business with;
whereas this IOU credit score is independent of the traditional credit score used in the industry;
whereas every user will have the opportunity to start from fresh and establish their IOU Credit Score and that their traditional credit score will not factor in at all and users are required to judge other users in the system based on their IOU performance and not their traditional credit performance;
whereas the IOU Credit Score are calculated using many different forms of IOU (I Owe You) platform data and that this data is grouped into many categories such as IOU payment history (which consists of number of IOU transactions, dollar amounts of IOU transactions, average length to IOU repayment), IOU amounts owed vs. IOU credit, length of IOU credit history, number of users with credit history with, working with other users in different business categories, and loan mix if applicable;
whereas the more users that other users have good working relationships and pay back regularly, the higher their overall IOU credit score will be;
whereas IOU Credit Score considers both positive and negative information in the IOU report and negative information will be such items as late payments, not paying backs IOU credit/loans, or paying them back very late;
whereas re-establishing a good track record of making payments on time changing related bad habits will raise overall IOU Credit Score;
whereas the IOU (I Owe You) platform has different components of calculating IOU Credit Score and the overall method to determine IOU credit score for a particular user at any given particular moment is based on system algorithm;
whereas users IOU Credit Score can change frequently based on the constant input of new data (transactions and other related factors);
whereas a particular component of score calculating is IOU Payment History which includes which other user accounts were paid on time, the amounts owed, number of other transactions, and the length of any late or no payments;
whereas another particular component of score calculating is IOU amounts owed vs. IOU credit which includes the number of other users accounts that are owed money to, the type of debt, its total amount and also included is the ratio of money owed to credit available;
whereas another particular component of score calculating is length of IOU credit history which includes a wide range of variables such how long user has been on the platform, age of transactions with users newest, oldest, average age of users, also included is the different types of users (example: different business categories) and user transactions with them;
whereas the IOU (I Owe You) platform has a rating system for its IOU credit score that ranges from 200 Points to 1,000 points and also using a grading system A+, A, A−, B+, B, B−, C+, C, C−, D+, D, D−, and F+, F, F−;

15. A computer implemented method that provides users with the ability to safety and easily provide credit or to lend money to other users and facilitate all transaction details on platform using an IOU (I Owe You) form of currency comprising;
different modules which can be used alone or in combination;
allows users with the ability to securely and easily setup and track transactions, establish repayment terms of their choice, interest rate and other related functions with others in one platform from account signup through to funds settlement;
users access the platform from a cell phone, tablet, laptop computer, desktop computer or other related internet browser.

16. The method of claim 15, further comprising:
whereas users can request from or offer other users credit for their products and/or services and pay later with an IOU (I Owe You) form of Currency;
whereas all transactions get recorded in both user accounts with all transaction details;
whereas users transfer funds from their bank account to their IOU (I Owe You) account and then can pay back other users directly that are owned money either by or before due dates;
whereas transactions are conducted in those users particular county's form of currency. (example: If US account then form of currency will be US Dollar);
whereas transactions can be conducted in any currency and converted to other user's currency by using platform currency converter module;
whereas all platform communications, transmissions, customer data, etc. that are processed on platform regardless of device or method use the standard and ongoing industry practice of security measures, encryption and protection protocols to ensure safety at all time for the platform and its users;

17. The method of claim 15, further comprising:
receiving a request from a user to search for other users on the system; by entering other user's info such as personal name, email address, or phone number for individual users, and business name, address, or phone number for business or institution users;
whereas an alternative method also exists to find other users on the system, by using system's custom barcode generator and scanner features,
thereafter generating a notification to other user on system that initial user wants to connect and request access to interact with them on platform;
thereafter allowing the requested user to accept or deny access to interact with the other user that requested it;
whereas if other user that is being searched for does not currently have an account on the system, user can have system send other user an invitation by email and or text by having their contacts merged with system or manually entering the other user cell phone number and or email address;

18. The method of claim 16, further comprising:
whereas users can extend their product or service to other users in exchange for a pay later IOU (I Owe You) Credit form of currency;
whereas these users set the credit limit levels directly to other users to purchase their products and or service on IOU (I Own You) Credit and are not based on getting approval from by any banking, credit card, financial institution, or government agency, or based on users traditional credit history report, income, tax returns, or collateral needed;
whereas users can base their credit making decisions on other users IOU (I Owe You) Credit details data which consists of information such as year joined, system IOU (I Owe You) Score, numbers of transactions, combined credit limit from other users, number of vendors, payback history, loans received or given, overall rating, etc;
whereas users can make informed financial decisions on whether to extend credit, how much, and the other related terms such as credit length and interest;

19. The method of claim 15, further comprising and providing individuals and businesses with an alternative form of pay later credit and borrowing from the traditional methods which includes credit cards, short term loans, payday loans, and the like;
whereas the IOU (I Owe You) platform allows users to extend or offer credit and/or loans directly to one another and function as the their own bank or credit card company in the credit and loan making decision process;

20. The method of claim 15, further comprising:
whereas the IOU (I Owe You) platform does not allow duplicate accounts, second accounts, fake name accounts, personal alias accounts (only businesses can have a fictitious name tied to a corporate entity), and the like
whereas to preserve the integrity of the IOU (I Owe You) platform each individual user or business entity is allowed only one account, and users can delete their account if they choose or the IOU (I Owe You) platform may also delete a user that violates its terms and conditions, and if a user deletes their account and then at a later time wants to open an account verification process starts again but new account is not created, old user account will be reinstated with IOU Credit History, balances, and all other account functions intact to its original state when user decided to delete;
whereas once a user is registered and validated, his/her profile, including name, address, phone number, email address, password, etc. is stored in the IOU (I Owe You) platform database and a particular account will be associated with that user;
